(19) United States
(12) Patent Application Publication
(10) Pub. No.: US 2006/0265413 A1
(43) Pub. Date: Nov. 23, 2006

(54) User interface and method for sorting data records

(76) Inventor: Andrew R. Blencowe, Windham, NH (US)

Correspondence Address: Russ Weinzimmer, Suite 204, 614 Nashua Street, Milford, NH, 03055, US

(21) Appl. No.: 11/132,755

(22) Filed: May 18, 2005

(51) Int. Cl. G06F 7/00

(52) U.S. Cl. 707/102

(57) ABSTRACT

A user interface is provided for sorting a plurality of data records. The user interface includes a data display region for displaying the plurality of data records as a plurality of data columns. Also, a sort control region includes a plurality of sort control bars aligned with the plurality of data columns, each sort control bar providing sorting of a data column in accordance with a sort priority selected by a user, and providing a visual indication of the sort priority and direction of a respective data column. The invention elegantly enables a user to sort multiple columns of data by simply clicking near the top or bottom of each column to establish at least first and second sort keys, as well as a sort direction for each sorted column. The sort priority and sort direction for each column is visually indicated near the top or bottom of each column.

### FIELD OF THE INVENTION

The present invention relates to sorting data records having data elements arranged in columns displayed on a computer screen, and more particularly to a user interface and method for visually facilitating sorting columns of data.

### BACKGROUND OF THE INVENTION

Many computer programs, such as spreadsheets, e-mail clients, and other commonly used software applications, present and manage data arranged as a plurality of columns. Each column of data can be sorted alphanumerically. The columns can be sorted in any of a variety of orders, e.g., first column then third column, or second, then first, then fourth column.

For example, in an email client with three columns labeled “From”, “Subject”, and “Date Received”, records (one record per email received) can be first sorted by “Date Received”, and then by “Subject”. Thus, the first sort is based on the “Date Received”, and then the results of that sort are sorted based on the “Subject” of each email. Consequently, all the emails received on the same date are sorted by “Subject”. Looking up and down the “Subject” column one can see a separate alphanumeric sorting for each date of the “Date Received” column. Also, looking up and down the “Date Received” column, one sees the emails sorted by date, all the emails with the same date being grouped together.

Conversely, records (one record per email received) can be first sorted by “Subject”, and then by “Date Received”. Thus, the first sort is based on the “Subject”, and then the results of that sort are sorted based on the “Date Received” of each email. Consequently, all the emails having the same “Subject” are sorted by “Date Received”. Looking up and down the “Date Received” column one can see a separate alphanumeric sorting for each subject of the “Subject” column. Also, looking up and down the “Subject” column, one sees the emails sorted by subject, all the emails with the same subject being grouped together.

Also, there can be more than two sorts; a third sort based on third column (e.g., “Sender”), and a fourth sort based on a fourth column (e.g., “Size”) are also possibly useful. In other applications, fifth and sixth sorts may also be useful.

Each column can be sorted in ascending alphanumeric order (e.g., A to Z, or 1 to 9), or descending alphanumeric order (e.g., Z to A, or 9 to 1). The sort direction (ascending or descending) is sometimes indicated by a triangle pointing up or down, and possibly may also be indicated by a color change (e.g., red to blue).

In a typical electronic spreadsheet, such as the electronic spreadsheet Excel™ sold by Microsoft™, there are typically a plurality of columns of data. In Microsoft™ Excel™, using a drop-down menu, a separate sort dialog box is selected that enables a user to select the order in which the columns will be sorted, and the direction in which each column will be sorted (ascending or descending). However, after the order and direction of sorting is selected, the sort is performed, and the sort dialog box provides only a text summary of the sort order and direction, sometimes overlapping with and obscuring the sorted data. A further disadvantage is that opening a separate sort dialog box is cumbersome, and is not intuitive to the user. Another disadvantage is that the sort order and direction of the data can be determined only by reading the data after the sort dialog box is closed.

In a typical e-mail client program, such as Microsoft™ Outlook Express™, the user interface includes a plurality of columns for data, each column including a column heading, with e-mail data underneath each column heading. The user selects a column by clicking on the heading of the column, and the email data is sorted based on the email data underneath the column heading.

If the same column heading is clicked again, the direction of the sort is reversed. Thus, the program sorts the data in each column under each column heading in ascending or descending order. A triangular-shaped arrow embedded in the heading points down to indicate descending sort direction, and points up to indicate ascending sort direction.

Each column can be selected individually. However, when another column is selected, the previously selected column is deselected. Thus, a disadvantage of this program is that there is no way to select multiple columns, and consequently it is not possible to sort a plurality of selected columns in an order determined by a user.

### SUMMARY OF THE INVENTION

In a general aspect of the invention, a computer user interface is provided for displaying and sorting a plurality of data records, each data record having a plurality of data elements. The computer user interface includes a data display region for displaying the plurality of data records in aligned relationship such that the plurality of data elements of each data record together form a plurality of data columns; and a sort control region having a plurality of sort control bars in aligned relationship with the plurality of data columns, each sort control bar providing sorting of a respective data column in accordance with a sort priority upon selection by a user, and providing a visual indication of the sort priority of a respective data column.

In a preferred embodiment, each sort control bar provides sorting promptly upon being clicked by a user of the computer interface. In another preferred embodiment, each sort control bar also provides a visual indication of the sort direction of a respective data column. In a further preferred embodiment, each sort control bar provides a visual indication of sort priority by including a triangle of a certain size, the size of the triangle indicating the sort priority. In yet another preferred embodiment, each sort control bar provides a visual indication of sort priority and sort direction by including a triangle of a certain size and a certain orientation, the size of the triangle indicating the sort priority, the orientation of the triangle indicating the sort direction. In an alternate preferred embodiment, each sort control bar provides a visual indication of sort priority by including background of a certain color intensity, the intensity of the color indicating the sort priority.

In an alternate embodiment, each sort control bar provides a visual indication of sort priority by including a number of circles, the number of circles indicating the sort priority.

In a further preferred embodiment, each sort control bar provides a visual indication of sort priority by including both a background of a certain color intensity and a triangle of a certain size, the color intensity of the background and the size of the triangle both indicating the sort priority.

In some preferred embodiments, each sort control bar provides sorting of a respective data column in accordance with a sort priority upon selection by a user, the sort priority being determined by an order in which the plurality of sort control bars is clicked by a user. In some embodiments, the order in which the plurality of sort control bars is clicked by a user results in sorting such that “first clicked, first sorted”. In other embodiments, the order in which the plurality of sort control bars is clicked by a user results in sorting such that “first clicked, last sorted”.

In preferred embodiments, the sort direction of the respective data column is determined by a number of clicks upon a respective sort control bar. In other preferred embodiments, the sort direction of the respective data column is reversed by clicking on a respective sort control bar. In further preferred embodiments, a number of sorted columns is decreased by a user repeatedly clicking on a selected sort control bar, possibly leaving at least one column unsorted. In yet further preferred embodiments, a number of sorted columns is increased by a user clicking on a previously un-clicked sort control bar.

In another general aspect of the invention, a computer user interface is provided for displaying and sorting a plurality of data records, each data record having a plurality of data elements. The computer user interface includes a data display region for displaying the plurality of data records in aligned relationship such that the plurality of data elements of each data record together form a plurality of data columns; and a sort control region having a plurality of sort control bars in aligned relationship with the plurality of data columns, each sort control bar providing sorting of a respective data column in accordance with a sort priority upon selection by a user, and providing a visual indication of the sort priority and sort direction of a respective data column, each sort control bar providing sorting promptly upon being clicked by a user of the computer interface.

In a preferred embodiment, each sort control bar provides a visual indication of sort priority and sort direction by including a triangle of a certain size and a certain orientation, the size of the triangle indicating the sort priority, the orientation of the triangle indicating the sort direction. In another preferred embodiment, each sort control bar provides a visual indication of sort priority by including background of a certain color intensity, the intensity of the color indicating the sort priority. In a further preferred embodiment, each sort control bar provides a visual indication of sort priority by including both a background of a certain color intensity and a triangle of a certain size, the color intensity of the background and the size of the triangle both indicating the sort priority. In yet another preferred embodiment, each sort control bar provides sorting of a respective data column in accordance with a sort priority upon selection by a user, the sort priority being determined by an order in which the plurality of sort control bars is clicked by a user.

The invention elegantly enables a user to sort multiple columns of data by simply clicking near the top or bottom of each column of data so as to establish at least first and second sort keys, as well as sort direction for each sorted column. The sort priority and sort direction for each column is visually indicated near the top or bottom of each column. Thus, no dialog window is needed to establish sort key order, or sort direction—such information is easily readable without using text, instead using geometric shapes and background colors, for example.

### BRIEF DESCRIPTION OF THE DRAWING

The invention will be more fully understood by reference to the detailed description, in conjunction with the following figures, wherein:

FIG. 1 is a screen shot of an embodiment of the present invention showing a plurality of email data records arranged so as to form a plurality of columns, also showing a sort control bar of the invention at the top of each column clicked by a user so as to sort the columns with three levels of sorting, all in an ascending direction;

FIG. 2 is a screen shot showing a sort control bar of the invention at the top of each column clicked by a user so as to sort the columns with four levels of sorting in both ascending and descending directions;

FIG. 3 is a screen shot of an embodiment of the present invention showing a plurality of database data records arranged so as to form a plurality of columns, also showing a sort control bar of the invention at the top of each column clicked by a user so as to sort the columns with two levels of sorting in both ascending and descending directions;

FIG. 4 is a screen shot showing a sort control bar of the invention at the top of each column clicked by a user so as to sort the columns with three levels of sorting in the descending direction;

FIG. 5 is a screen shot of an embodiment of the present invention showing a plurality of spreadsheet data records arranged so as to form a plurality of columns, also showing a sort control bar of the invention at the top of each column clicked by a user so as to sort the columns with three levels of sorting all in the ascending direction;

FIG. 6 is a screen shot showing a sort control bar of the invention at the top of each column clicked by a user so as to sort the columns with another three levels of sorting all in the ascending direction;

FIG. 7 is a screen shot showing a sort control bar of the invention at the top of each column clicked by a user so as to sort the columns with the three levels of sorting shown in FIG. 5, the first sort done in a descending direction, the remaining sorts done in the ascending direction;

FIG. 8 is a flow chart illustrating an implementation of a preferred embodiment of the invention;

FIG. 9 is a flow chart further illustrating the implementation of FIG. 8;

FIG. 10 is a flow chart illustrating Drawing List Control Header (Sort Control Bar);

FIG. 11 is a flow chart further illustrating the implementation of FIG. 10;

FIG. 12 is a flow chart illustrating List Control Header item drawing;

FIG. 13 is a flow chart further illustrating the implementation of FIG. 12; and

FIG. 14 is a flow chart illustrating Set Sort Key List.

### DETAILED DESCRIPTION OF THE EMBODIMENTS

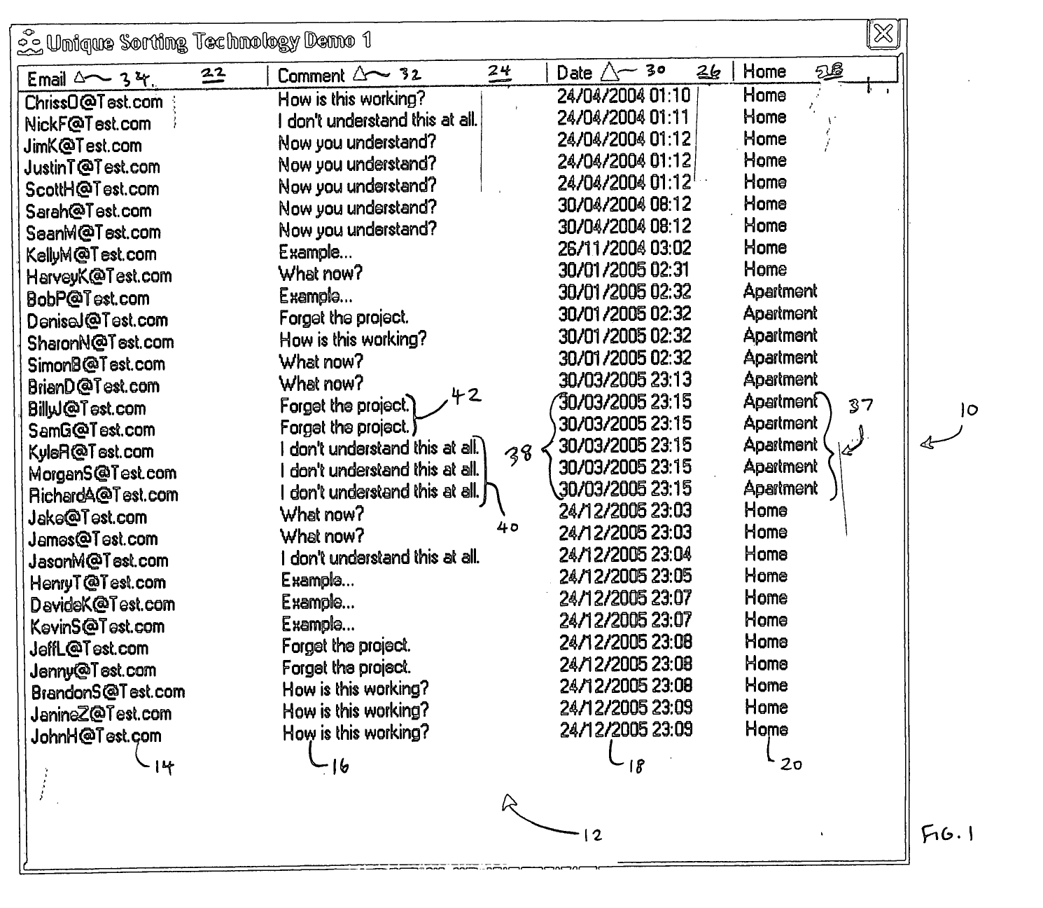

FIG. 1 shows a screen shot 10 of an embodiment of the present invention showing a plurality of email data records 12, each data record having a plurality of data elements 14, 16, 18, 20. The data elements of a data record all move together as a unit when a data records is moved during sorting within a set of data records. In FIG. 1, the data records 12 are spatially arranged such that the data elements 14, 16, 18, 20 of each data record align so as to form a plurality of columns of data elements. At the top of each column is a sort control bar 22, 24, 26, 28 of the invention at the top of each column. Each sort control bar 22, 24, 26, 28 is clickable, and depending on how a user clicks the sort control bars, sorting will be performed. Sort control bars can also reside at the bottom of each column in other embodiments.

For example, to perform sorting as shown in FIG. 1, in a preferred embodiment of the invention, the sort control bar 26 of the third column labeled “Date” is first clicked once. This has the effect of first sorting the records by the third element 18 only. Note that the there is a largest triangle 30 in the third sort control bar 26, and that this largest triangle 30 is pointing up. If this largest triangle 30 of the sort control bar 26 is clicked a second time, the sort direction will change from ascending to descending, and all the records will be sorted accordingly in response to the click of the user's pointing device, such as a mouse. Clicking a third time will again reverse sort direction, the records being resorted, and in some preferred embodiments, will also deselect the most recently selected column, such as a second or third selected column, if one exists. The user may click again on the deselected column to select it again, if desired.

When the sort direction changes, this is indicated by changing the direction of the triangle so as to point down. In some preferred embodiments, the background color of the sort control bar 26 can also change, for example from yellow to blue, or from blue to red.

Also, when the sort control bars first appear to the user, prior to clicking, they will not include any triangle, as shown in sort control bar 28, for example. The user is free to resort the records, or not. The user may choose to sort only on one data element, and so may click only one sort control bar situated over the column of the data element to be sorted. Also, the user may want to sort based on two data elements, in which case, the user clicks on a first sort control bar 26, and then a second control bar 24. Since each sort control bar 26 and 24 has been clicked only once in this case, their sort directions will be ascending by default. Further, the user may want to sort on three data elements, all in ascending direction. In this case, the user clicks sort control bars 26, 24, and 22, in that sequence. This situation is shown in FIG. 1, for example. Note that after clicking three sort control bars, there are three triangles of different sizes, the size of each triangle indicating the respective sort priority of the nearest column of data elements.

The order of clicking of the sort control bars 22, 24, 26, 28 is important because it determines the “sort priority”, also called the “sort order”. The sorting of the records is a hierarchical (or “nested”) sort because the first sort is based on a first chosen data element of each record, which may create subsets of data records having an identical first-chosen data element. These subsets may then each be sorted by a second-chosen data element. These chosen data elements are sometimes also called the “first sort key” (or the “primary sort key”), and the “second sort key” (or the “secondary sort key”).

In the present embodiment, the sort priority is determined directly by the order in which the user clicks the sort control bars over the columns, i.e., the first sort control bar clicked indicates the first sort key, the second sort control bar clicked indicates the second sort key, etc. However, other embodiments exist wherein the first sort control bar clicked is the last sort key, the second control bar clicked is the second-to-last sort key, etc. Thus, the last sort control bar clicked would become the primary sort key.

With reference again to FIG. 1, the sort priority (or sort order) is graphically indicated above each column of data elements. FIG. 1 shows one embodiment of how sort priority can be indicated, i.e., by using triangles of different sizes. Other ways of graphically indicating sort priority are also contemplated, such as using various numbers of triangles of the same size, or using multiple nested triangles, the more nested triangles within each sort control bar, the more primary the sort key.

Alternatively, sort priority can be visually indicated using one or more dots or bullets within each sort control bar. Of course, text could be used to indicate the “FIRST”, “SECOND”, and “THIRD” sort keys, for example. Another version could be a number within a circle, the number indicating the sort priority, such as “1”, “2”, and “3”, each within a circle within a sort control bar. The basic idea is that sort priority is indicated visually and/or graphically in a way that is spatially associated with each column.

Sort direction is also graphically indicated. The triangles shown in FIG. 1 indicate sort priority as well as sort direction. An upward pointing triangle indicates an ascending sort direction, for example. Alternatively, sort priority can be indicated with a number within a circle, and next to the circle can be an arrow pointing up or down, the circle and the arrow being within the same sort control bar over (or under) the respective sorted column.

Sort direction can also be graphically or visually indicated using color. Color can be used in conjunction with or instead of other ways of indicating sort priority. For example, the background of each sort control bar can be color-tinted, great intensity of the color-tint representing higher sort priority. Also, the color can change when the sort direction changes from ascending to descending, such as changing from blue to red. In other embodiments, the entire column background can be colored according to the sort priority and/or sort direction. For example, the color of the sort control bar, and/or the color of the background of the sort control bar, and/or the color of the background of each entire column can bear a color that indicates sort priority and/or sort direction.

Moreover, any other visual and/or graphical way of representing sort priority and/or sort direction in close conjunction with each column of data records can be used in accordance with the invention.

In FIG. 1, the primary sort key is the third data element, as indicated by the largest triangle being within the sort control bar that is over the column of third data elements. Once all the data records have been sorted by the primary sort key, it may be observed that there are subsets of records having the same third data element. Thus, each subset of data records having the same third data element can be further sorted based on a second sort key, such as the second data element of each record in FIG. 1.

For example, in FIG. 1, the subset of records 37 all have the same date and time 38, but have different comments: “Forget the project.” or “I don't understand this at all.” Clicking on the sort control bar 24 of the “Comment” column then sorts each subset of data records having identical first data elements in ascending order within each subset.

Note also that included within the subset of records 37 are two sub-subsets 40 and 42, each having identical second data elements. Clicking on the sort control bar 22 of the “Email” column then sorts each sub-subset 40 and 42 of data records having identical second data elements in ascending order within each sub-subset 40 and 42.

For this particular data set shown in FIG. 1, there is no further sorting possible, since there are no more subsets of records with identical first data elements, since all the first data elements of the collection of data records of FIG. 1 are unique. However, FIG. 1 shows that further hierarchical sorting is possible for other data sets, since sort control bars 22 and 28 are available for further nested sorting. The method of the invention can be extended to any number of sort control bars, but typically no more than four or five sort control bars will be useful.

To reduce the number of sort keys, thereby creating more sort control bars without any triangle, such as the sort control bar 28, the sort control bar of the primary sort key can be repeatedly toggled. Each two clicks will remove the lowest priority sort key until all the sort control bars do not have any triangles present and/or color, for example. To add sort keys, the user simply clicks on sort control bars without triangles in the order desired. Sorting actually occurs each time a sort control bar is clicked.

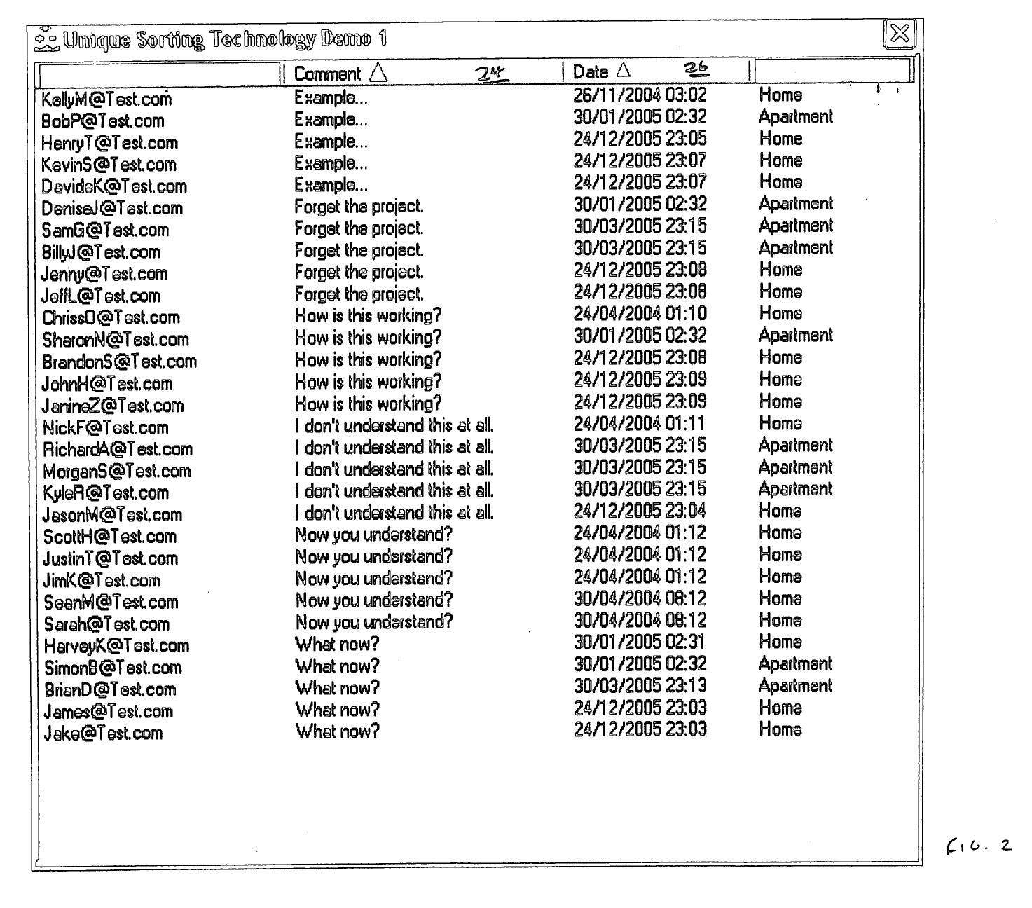

FIG. 2 is a screen shot of an embodiment of the present invention showing the plurality of email data records of FIG. 1, arranged such that the data elements of each data record form a plurality of columns. FIG. 2 again shows four sort control bars 22, 24, 26, 28 at the top of each column clicked by a user so as to sort the columns with four levels of sorting in both ascending and descending directions. In this case, the second sort control bar 24 has been clicked first, then the third sort control bar 26 was clicked, then the fourth sort control bar 28 was clicked twice so as to make it represent the third sort key, sorting in a descending direction, and then the first sort control bar 22 was clicked twice so as to sort in a descending direction. Note that the descending direction is visually indicated by reversing the direction of the triangle, regardless of the size of the triangle. In other embodiments, the color of the background of the sort control bar can change from yellow to blue, or from blue to red, for example.

Notice that the data records are first sorted according to the second elements of each record in an alphabetically ascending direction. Thus, the second element is the first sort key. After the first sort, there are six subsets that are formed, each subset of records having the same second data element, such as five data records, each having “Example . . . ” as the second data element.

The third sort control bar 36 is clicked second, which sorts each of the six subsets according to the date in ascending numeric order. Identical date and times all occur in the same place, so the third sort control bar 28 does not have any effect. Further, the fourth sort control bar 22 has no effect since all the first data elements are mutually distinct.

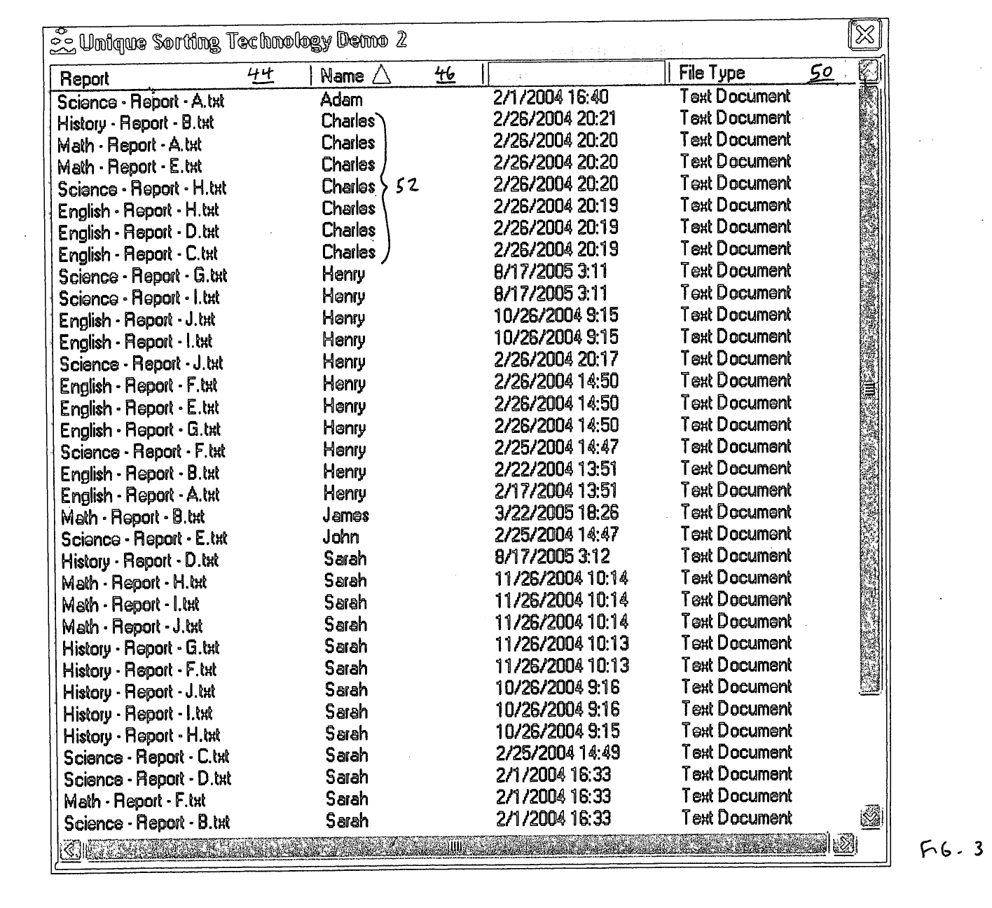

FIG. 3 is a screen shot of an embodiment of the present invention showing a plurality of database data records arranged so as to form a plurality of columns of data elements. At the top of each column are sort control bars 44, 46, 48, and 50, in this example bearing the labels “Report”, “Name”, “Date”, and “File Type”, respectively. The second data record has the first sort priority since the second sort control bar 46 was clicked first. Since the second sort control bar 46 was clicked only once, the sort direction is ascending.

Notice that since the third sort control bar 48 has been clicked second, and has been clicked twice, as visually indicated by a triangle that points downward (in other preferred embodiments, the background color of the sort control bar changes color) each sub-set of records having an identical second element, such as the subset 52 having the name “Charles”, is sorted in descending numerical direction. Thus, FIG. 3 shows two active sort control bars 46 and 48 of the invention, each at the top of a respective column, clicked by a user so as to sort the columns with two levels of sorting. The first sort is on “Name” in the ascending direction, and the second sort within each subset having the same name is on “Date” in a descending direction. The records with the same Name and Date are not sorted any further.

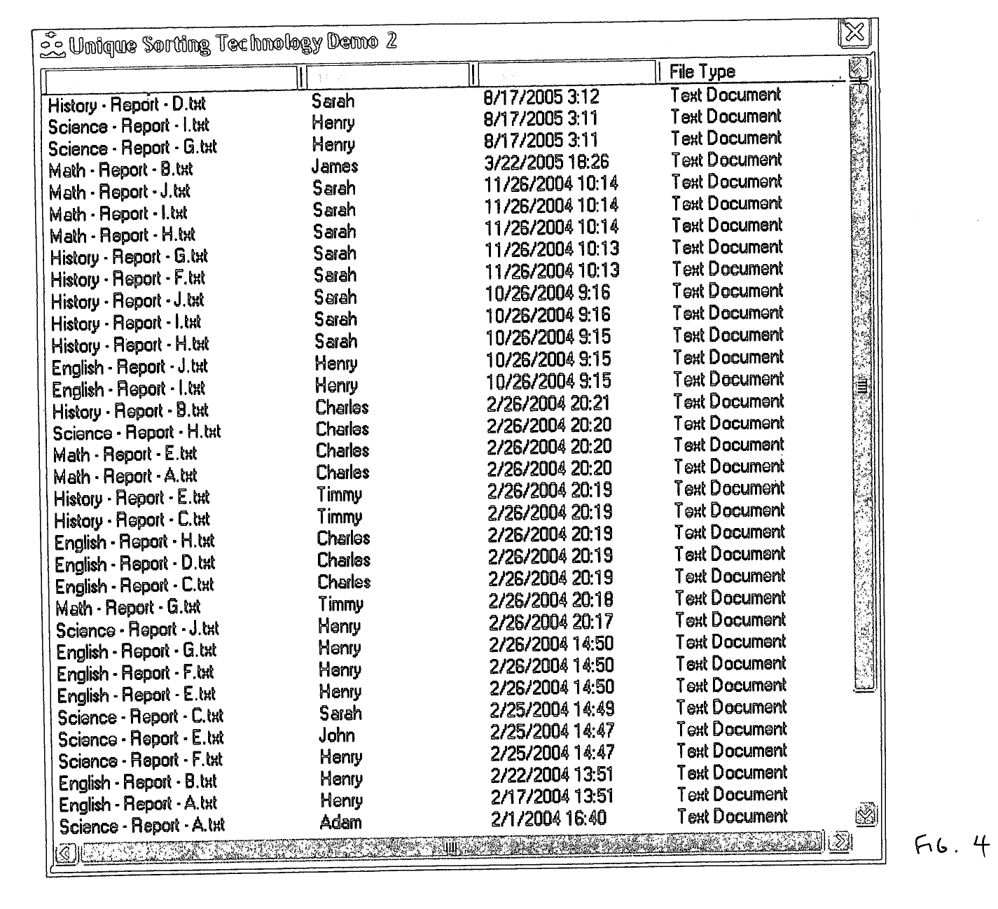

FIG. 4 is a screen shot showing the plurality of database data records of FIG. 3, arranged so as to form a plurality of columns. At the top of each column is a sort control bar of the invention, each sort control bar clicked twice so as to sort each of the first, second and third columns of data elements in a descending direction. Thus, each sort control bar includes a downward pointing triangle. In other preferred embodiments, the background of each of the active sort control bars is a color different from the color of a sort control bar clicked so as to sort in an ascending direction. Here, the third column is sorted first, then records with the same Date are sorted according to Name, and then records with the same Date and Name are sorted according to “Report”. This is a hierarchical or nested sort, the sort having three levels. The File Type is the same for each record, and is therefore not useful for sorting.

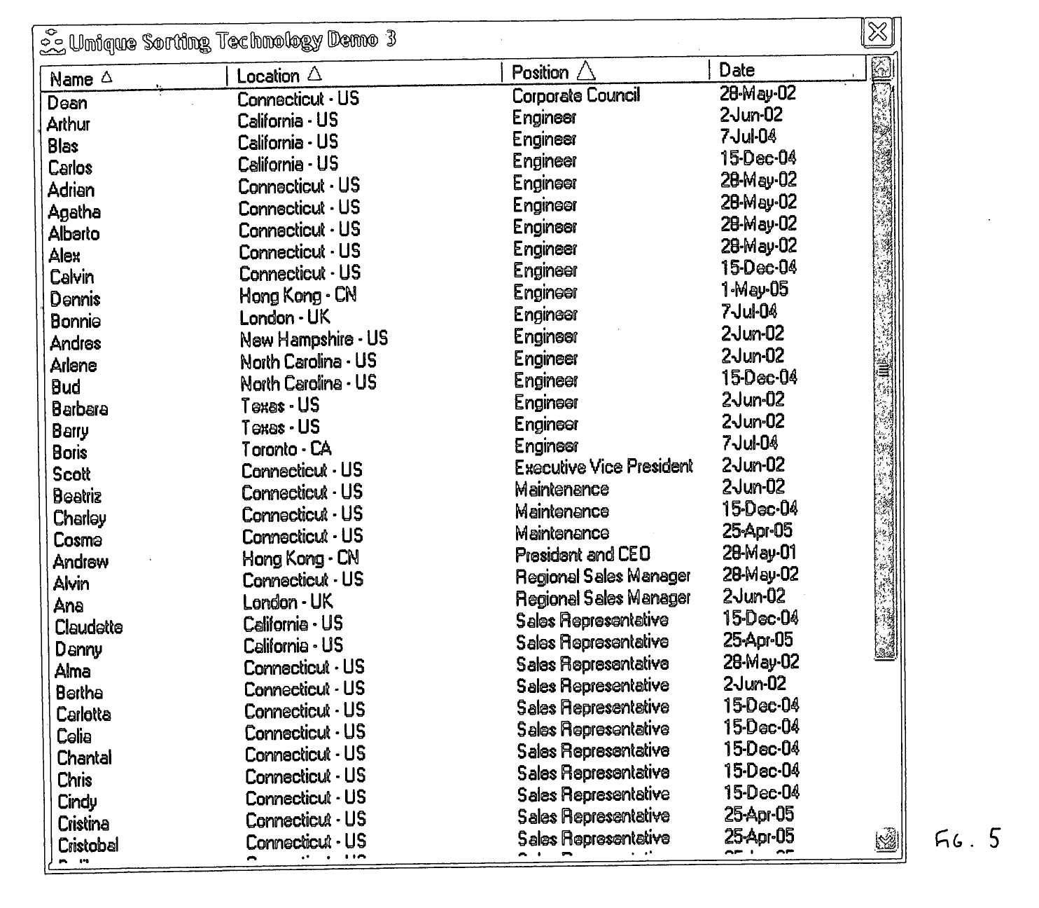

FIG. 5 is a screen shot of an embodiment of the present invention showing a plurality of spreadsheet data records arranged so as to form a plurality of columns of data elements. A sort control bar of the invention is located at the top of each column, the sort control bar being clicked by a user so as to sort the columns with three levels of sorting, the first, second, and third levels of sorting being all in the ascending direction. Notice that it is easy to first sort by “Position”, then sort all records having the same position, e.g., “Engineer”, being sorted by “Location”. One can then easily see which Engineers are at each location. The “Date” is irrelevant to this sort.

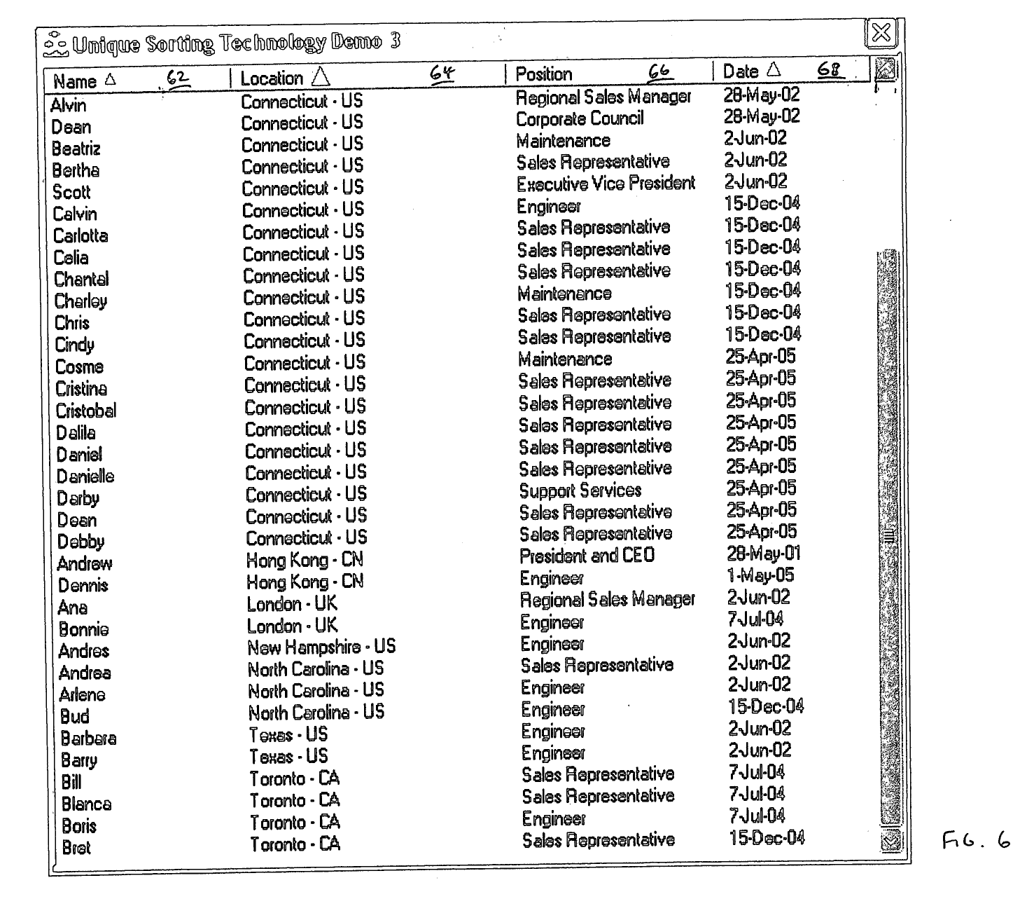

Alternatively, FIG. 6 is a screen shot of an embodiment of the present invention showing the same plurality of spreadsheet data records arranged so as to form a plurality of columns. However, the first sort is done on the second data element, labeled by “Location”, and then the second sort of all data records having the same “Location” is done using “Date”. This is clear by looking at the size of the triangles, if any, in each of the sort control bars 62, 64, 66, 68. The largest triangle is in the sort control bar 64, and so the associated second data element was sorted first. The second largest triangle is in the sort control bar 68, and so the associated fourth data element, i.e., “Date”, was sorted second. Consequently, records of the same location are sorted in ascending direction (triangle is pointing up) according to Date. The third largest (i.e., the smallest) triangle is in the sort control bar 62, and so the associated first data element, i.e., “Name” was sorted third. As a result, records having the same Location and Date are sorted alphabetically by Name, in ascending order since the triangle is pointing up. In this sort, the third data element of “Position” was not relevant, and so the third sort control bar was not clicked.

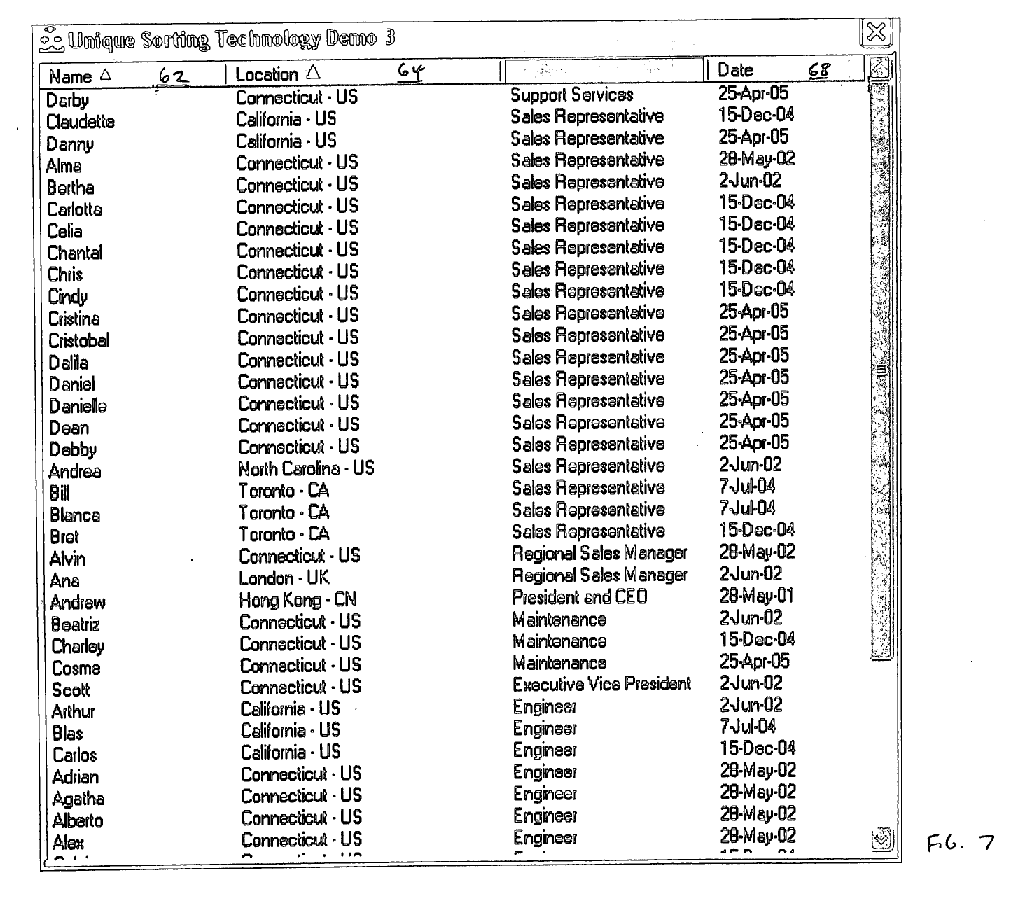

Alternatively, FIG. 7 is a screen shot of an embodiment of the present invention showing the same plurality of spreadsheet data records arranged so as to form a plurality of columns. However, the first sort is done on the third data element, labeled by “Position”, and then the second sort of all data records having the same “Position” is done using “Location”. This is clear by looking at the size of the triangles, if any, in each of the sort control bars 62, 64, 66, 68. The largest triangle is in the sort control bar 66, and so the associated third data element was sorted first, here in descending sort direction. The second largest triangle is in the sort control bar 64, and so the associated second data element, i.e., “Location”, was sorted second, here in ascending sort order. Consequently, records of the same Position are sorted in ascending direction (triangle is pointing up) according to Location.

The third largest (i.e., the smallest) triangle is in the sort control bar 62, and so the associated first data element, i.e., “Name” was sorted third. As a result, records having the same Position and Location are sorted alphabetically by Name, in ascending order since the triangle is pointing up. In this sort, the fourth data element of “Date” was not relevant, and so the Fourth sort control bar was not clicked. FIG. 7 shows an example of the data records being sorted with the three levels of sorting, the first sort done in a descending direction, as indicated by a downward-pointing triangle (and in some preferred embodiments, also a background color that is different from the background color of the columns sorted in an ascending direction), the remaining sorts done in the ascending direction.

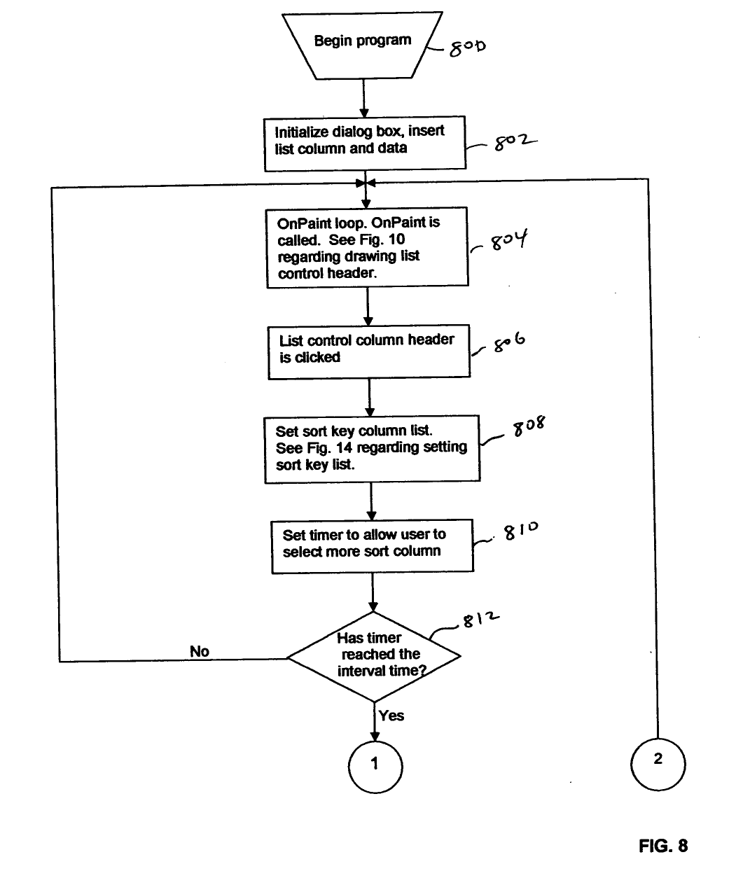

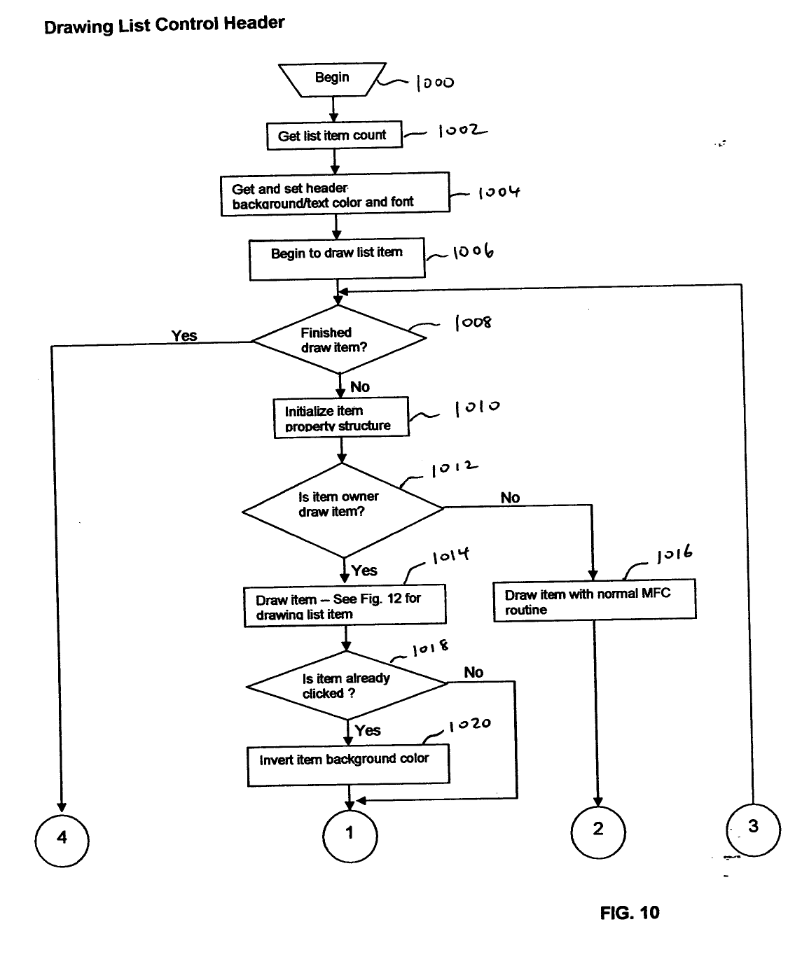

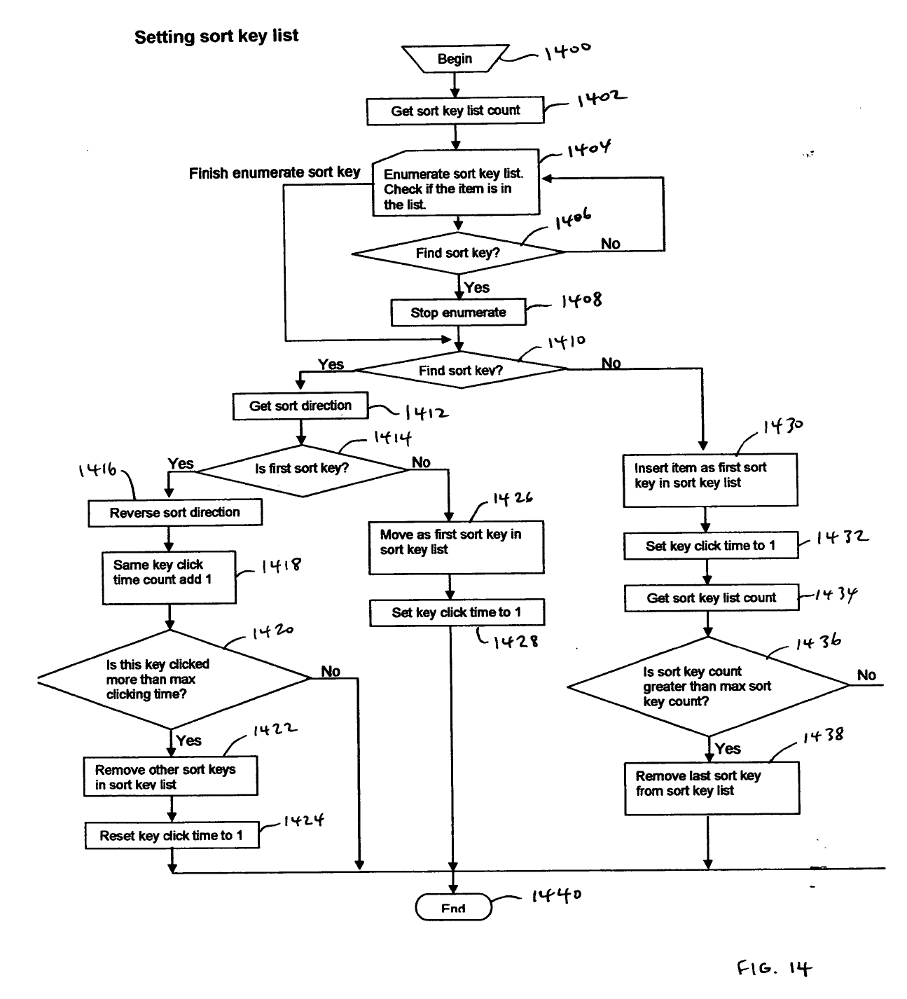

With reference to FIG. 8, a top-level flow chart illustrating an implementation of a preferred embodiment of the invention is presented. After the program begins 800, a dialog box is initialized, list column and data being inserted 802. Next, the OnPaint loop begins, wherein OnPaint is called 804. FIG. 10 details the steps of drawing the list control column headers (also called “sort control bars” above). When a list control column header (sort control bar) is clicked by a user 806, the sort key column list is set 808, as detailed in FIG. 14. Next, a timer is set to allow the user to select more columns to sort by clicking on more sort control bars 810.

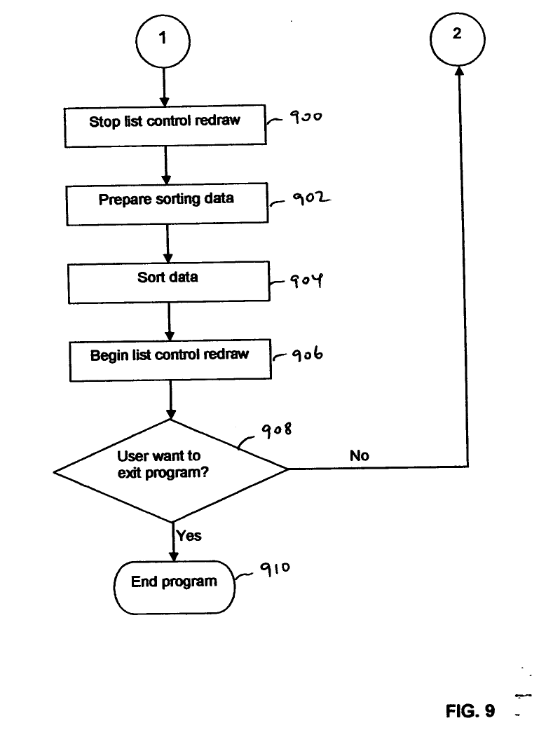

Referring to FIG. 9, if the timer has not reached a preset interval time 812, program control goes back to step 804. Else, if the timer has reached a preset interval time 812, then list control redraw stops 900, sorting data is prepared 902, the data is sorted 904, and then list control redraw is begun 906. If the user wants to exit the program 908, the user ends the program 910. Else, program control goes back to step 804 of FIG. 8.

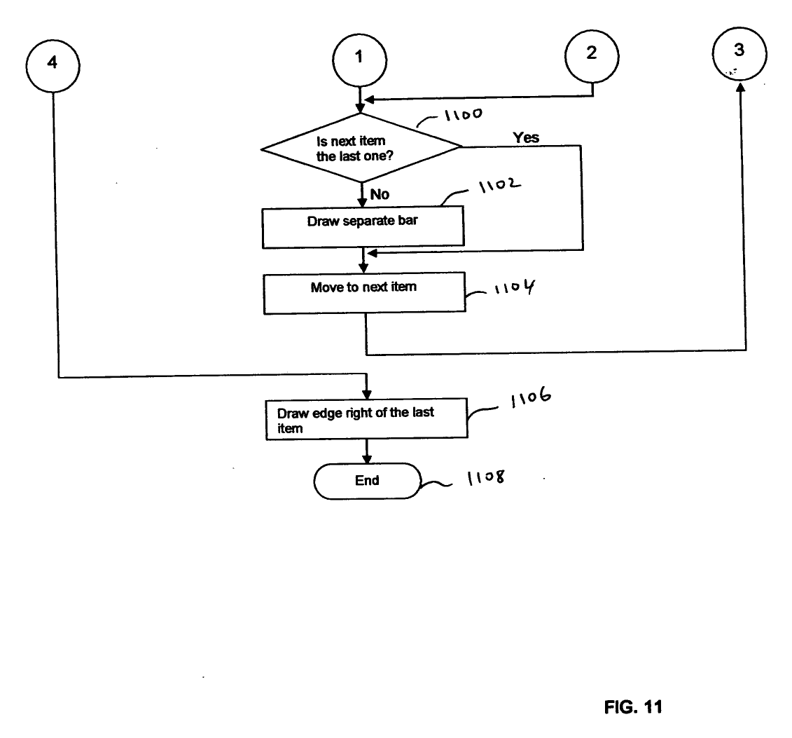

With reference to FIG. 10, to draw a list column control header (sort control bar), the program begins 1000, and then gets a list item count 1002. Next, the program gets and sets header background/text color and font 1004. Then, the program begins to draw a list item 1006. If a list item is not finished 1008 being drawn, then initialize item property structure 1010. As shown in FIG. 11, if a list item is finished being drawn 1008, then draw an edge right of the last item 1106 and end 1108.

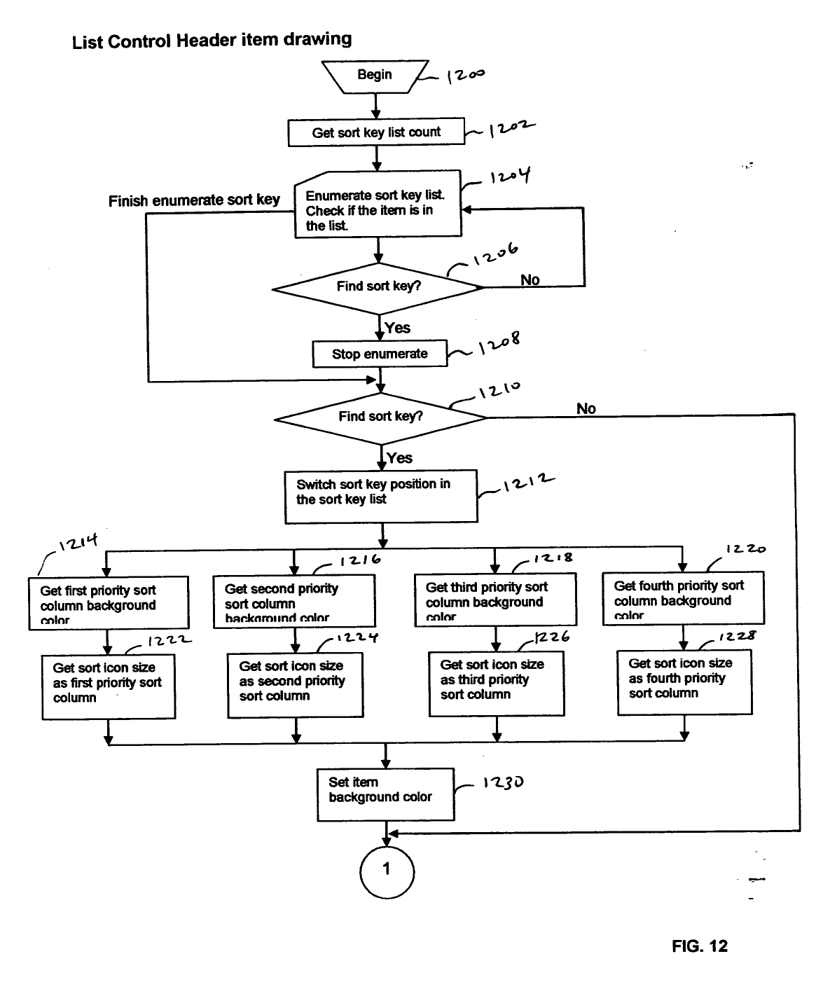

After initializing the item property structure 1010, the program determines whether the item owner is draw item 1012. If yes, then draw item 1014 using the steps set forth in FIG. 12. If no, then draw item with normal MFC routine 1016, and go to step 1100 of FIG. 11.

After step 1014, if the item is already clicked 1018, then invert item background color 1020, and then go to step 1100 of FIG. 11. If the item is not already clicked 1018, then just go to step 1100 of FIG. 11.

Referring to FIG. 11, if the next item is not the last item 1100, then draw a separating bar 1102, and then move to the next item 1104, returning back to step 1008. If the next item is the last item 1100, then just move to the next item 1104, returning back to step 1008. At 1008, if there are no more items to be drawn, then draw an edge to the right of the last item 1106, and then end 1108.

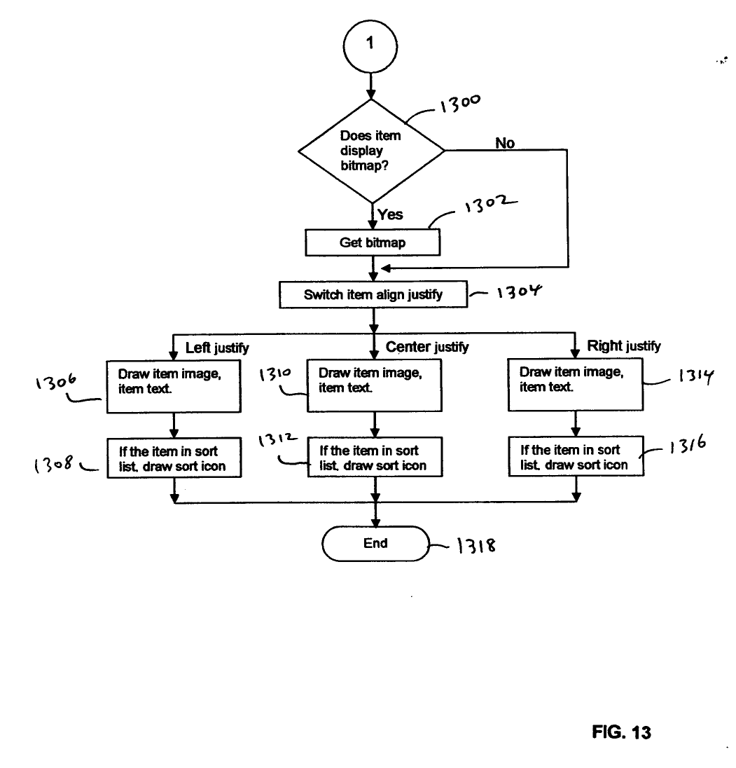

With reference to FIG. 12, regarding List Control Header item drawing, after the program begins 1200, the program gets the sort key list count 1202. To do so, the sort key list is enumerated 1204; the program checks whether an item is in the list 1204. If a sort key is not found, return to step 1204, and if a sort key is found, stop enumerating 1208. Next, the program tries to find a sort key 1210, and if one is found, the position of the found sort key is switched in the sort key list 1212. Then, the program gets the first, second, third, and fourth priority sort column background colors 1214, 1216, 1218, 1220, and then gets the sort icon size as first, second, third and fourth priority sort columns 1222, 1224, 1226, 1228. Then, the item background color is set 1230, and the program moves on to step 1300 in FIG. 13. If no sort key is found, at step 1210, the program moves directly to step 1300 in FIG. 13.

At step 1300, the program determines whether the item displays a bitmap 1300. If it does, the program gets the bitmap 1302, and proceeds to step 1304, whereupon the program performs the operation switch item align justify 1304. For each of Left justify, Center justify, and Right justify, Draw item image and item text 1306, 1310, 1314 are performed, and then if the item is in the sort list, the sort icon is drawn 1308, 1312, 1316, and then the routine ends 1318.

As required at step 808 of FIG. 8, FIG. 14 illustrates setting the sort key list starting at 1400. The program gets the sort key list count 1402. To do so, the sort key list is enumerated 1404; the program checks whether an item is in the list 1404. If a sort key is not found, return to step 1404, and if a sort key is found, stop enumerating 1408. Next, the program tries to find a sort key 1410, and if one is found, the program gets the sort direction 1412. If it's the first sort key 1414, then reverse the sort direction 1416, and add 1 to the same key click times count 1418. If this sort key was not clicked more than the maximum number of clicks 1420, then end 1440. If the sort key was clicked more than the maximum number of clicks, then remove other sort keys in the sort key list 1422, and then reset key click times to 1 1424.

After finding a sort key 1410, and getting the sort direction 1412, if the sort key found is not a first sort key 1414, then move as first sort key in sort key list 1426, set key click times to 1 1428, and then end 1440.

If a sort key is not found 1410, then insert the item as first sort key in sort key list 1430, set key click times to 1 1432, get sort key list count 1434, and ask whether the sort key count is greater than the max sort key count 1436. If it is, then remove the last sort key from the sort key list 1438, and then end 1440. If it's not, then just end 1440.

Other modifications and implementations will occur to those skilled in the art without departing from the spirit and the scope of the invention as claimed. Accordingly, the above description is not intended to limit the invention except as indicated in the following claims.

1. A computer user interface for displaying and sorting a plurality of data records, each data record having a plurality of data elements, the computer user interface comprising:
a data display region for displaying the plurality of data records in aligned relationship such that the plurality of data elements of each data record together form a plurality of data columns; and
a sort control region having a plurality of sort control bars in aligned relationship with the plurality of data columns, each sort control bar providing sorting of a respective data column in accordance with a sort priority upon selection by a user, and providing a visual indication of the sort priority of a respective data column.

2. The computer user interface of claim 1, wherein each sort control bar provides sorting promptly upon being clicked by a user of the computer interface.

3. The computer user interface of claim 1, wherein each sort control bar also provides a visual indication of the sort direction of a respective data column.

4. The computer user interface of claim 1, wherein each sort control bar provides a visual indication of sort priority by including a triangle of a certain size, the size of the triangle indicating the sort priority.

5. The computer user interface of claim 1, wherein each sort control bar provides a visual indication of sort priority and sort direction by including a triangle of a certain size and a certain orientation, the size of the triangle indicating the sort priority, the orientation of the triangle indicating the sort direction.

6. The computer user interface of claim 1, wherein each sort control bar provides a visual indication of sort priority by including background of a certain color intensity, the intensity of the color indicating the sort priority.

7. The computer user interface of claim 1, wherein each sort control bar provides a visual indication of sort priority by including a number of circles, the number of circles indicating the sort priority.

8. The computer user interface of claim 1, wherein each sort control bar provides a visual indication of sort priority by including both a background of a certain color intensity and a triangle of a certain size, the color intensity of the background and the size of the triangle both indicating the sort priority.

9. The computer user interface of claim 1, wherein each sort control bar provides sorting of a respective data column in accordance with a sort priority upon selection by a user, the sort priority being determined by an order in which the plurality of sort control bars is clicked by a user.

10. The computer user interface of claim 9, wherein the order in which the plurality of sort control bars is clicked by a user results in sorting such that “first clicked, first sorted”.

11. The computer user interface of claim 9, wherein the order in which the plurality of sort control bars is clicked by a user results in sorting such that “first clicked, last sorted”.

12. The computer user interface of claim 3, wherein the sort direction of the respective data column is determined by a number of clicks upon a respective sort control bar.

13. The computer user interface of claim 3, wherein the sort direction of the respective data column is reversed by clicking on a respective sort control bar.

14. The computer user interface of claim 1, wherein a number of sorted columns is decreased by a user repeatedly clicking on a selected sort control bar, possibly leaving at least one column unsorted.

15. The computer user interface of claim 1, wherein a number of sorted columns is increased by a user clicking on a previously un-clicked sort control bar.

16. A computer user interface for displaying and sorting a plurality of data records, each data record having a plurality of data elements, the computer user interface comprising:
a data display region for displaying the plurality of data records in aligned relationship such that the plurality of data elements of each data record together form a plurality of data columns; and
a sort control region having a plurality of sort control bars in aligned relationship with the plurality of data columns, each sort control bar providing sorting of a respective data column in accordance with a sort priority upon selection by a user, and providing a visual indication of the sort priority and sort direction of a respective data column, each sort control bar providing sorting promptly upon being clicked by a user of the computer interface.

17. The computer user interface of claim 16, wherein each sort control bar provides a visual indication of sort priority and sort direction by including a triangle of a certain size and a certain orientation, the size of the triangle indicating the sort priority, the orientation of the triangle indicating the sort direction.

18. The computer user interface of claim 16, wherein each sort control bar provides a visual indication of sort priority by including background of a certain color intensity, the intensity of the color indicating the sort priority.

19. The computer user interface of claim 16, wherein each sort control bar provides a visual indication of sort priority by including both a background of a certain color intensity and a triangle of a certain size, the color intensity of the background and the size of the triangle both indicating the sort priority.

20. The computer user interface of claim 16, wherein each sort control bar provides sorting of a respective data column in accordance with a sort priority upon selection by a user, the sort priority being determined by an order in which the plurality of sort control bars is clicked by a user.
